(19) United States
(12) Patent Application Publication
(10) Pub. No.: US 2003/0046250 A1
(43) Pub. Date: Mar. 6, 2003

(54) System and method for integrated reliability and warranty financial planning

(76) Inventors: Dorothea Kuettner, Mountain View, CA (US); Steve Kakouros, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/941,448

(22) Filed: Aug. 28, 2001

(51) Int. Cl. G06F 17/00

(52) U.S. Cl. 705/400

(57) ABSTRACT

An integrated reliability and financial planning system. The system uses contemporary and historical information on product warranty events, shipments and installed base to determine expected events over time. Based upon the expected event rate and warranty structure, the warranty cost for a product is predicted over the warranty life of the product. The resources required for service and support of the product are determined, and accruals and de-accruals for warranty expenses are planned for automatically, The system also provides for the examination of alternative scenarios to determine the impact of warranty structural changes and event rate changes.

### BACKGROUND OF THE INVENTION

1. Field of the Invention

This invention relates to reliability analysis and warranty financial planning. In particular, the invention relates to the integration of reliability analysis and warranty financial planning.

2. Related Art

Reliability modeling is well known as an engineering practice, but is seldom used for financial planning purposes. Data collected regarding the performance and failure of a product is often used directly by design and manufacturing engineering, whereas such data is typically condensed or filtered when used by financial planning organizations, if it is used at all. Time averages or sums integrated over an extended period of time are typical examples of condensed data. Because these data are historical in nature, they provide a poor basis for obtaining an understanding of contemporary cost behavior or accurate predictions in time. Failures do not express the exact number (of instances) of events that relate to warranty cost.

A product warranty is often a differentiator for sales. When two products are similar in performance and cost, or have technical differences that are not easily grasped by the consumer, the difference between the warranties associated with each product can be a decisive sales factor. However, adopting a new warranty policy in order to compete in the market place entails risk when the cost associated with the newly adopted policy cannot be assessed.

When new products are introduced or established products are changed, the product performance and the service and support requirements are largely unknown. Conventional cost management techniques require significant period of time for collecting the raw data that can be used in producing the initial set of time averaged or time integrated data. Because of this time lag, the initial financial planning period is prone to inaccuracies that lead to inefficient allocation of resources.

Thus, the need exists for an improved approach to warranty financial planning that is based upon product data that is more specific than time averaged or time integrated data. There is also a need for system and method of predicting the outcome of changes in warranty policy for a product so that associated financial risks can be assessed. There is a further need for a capability for planning for the allocation of resources for service and support for products under warranty.

### SUMMARY OF THE INVENTION

Accordingly, it is an object of the present invention to provide a warranty financial planning system that is based upon warranty event prediction data from a reliability modeling module and thus capable of more accurate, time resolved warranty event prediction. It is a further object of the present invention to use the time resolved event prediction to provide accurate planning for warranty accruals and budgeting for service and support. It is also an object to provide a capability for examining alternative scenarios based upon synthetic data to aid in marketing and pricing strategies. These and other objects and advantages of the present invention and others not specifically recited above will be described in more detail herein.

An integrated reliability and financial planning system is disclosed. The system uses contemporary and historical information on product warranty events, product shipments, and installed product base (collectively referred to as raw data) to determine expected events over time. Based upon the expected event rate and warranty structure, the warranty cost for a product is predicted over the warranty life of the product. The resources required for service and support of the product are determined, and accruals and de-accruals for warranty expenses are planned for automatically. The system also provides for the examination of alternative scenarios to determine the impact of warranty structural changes and failure rate changes.

In one embodiment of the present invention, an event forecasting engine is coupled to a warranty cost prediction module. The event forecasting engine is designed to accept time dependent data regarding product shipments, installed product base and warranty events. An appropriate statistical method is used by the event forecasting engine to determine expected events over time. The time resolved expected event data is input to the warranty cost prediction module in combination with data describing the product warranty structure. The warranty cost prediction module then provides a prediction of warranty cost over the warranty life of the product.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a computer system forming a part of a system in accordance with an embodiment of the present claimed invention.

FIG. 2 shows a functional block diagram for a system in accordance with an embodiment of the present claimed invention.

FIG. 3 shows a flowchart for a method in accordance with an embodiment with an embodiment of the present claimed invention.

FIG. 4 shows a comparison between a conventional constant event rate assumption and a time variable failure rate in accordance with an embodiment of the present claimed invention, including a Variable Event Rate Model (VERM).

FIG. 5 shows a comparison of actual event data with a conventional prediction and a prediction in accordance with an embodiment of the present claimed invention.

FIG. 6 shows a comparison of actual accrued cost data with a conventional practice and a prediction in accordance with an embodiment of the present claimed invention.

### DETAILED DESCRIPTION OF THE INVENTION

In the following detailed description of the present invention, a system and method for integrated reliability and financial planning, numerous specific details are set forth in order to provide a thorough understanding of the present invention. However, it will be obvious to one skilled in the art that the present Invention may be practiced without these specific details. In other instances well known methods, procedures, components, and circuits have not been described in detail so as not to unnecessarily obscure aspects of the present invention

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals a bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the disclosure of the present invention, terms such as “processing” or “computing” or “calculating” or “computing” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's registers or memories or other such information storage, transmission or display devices.

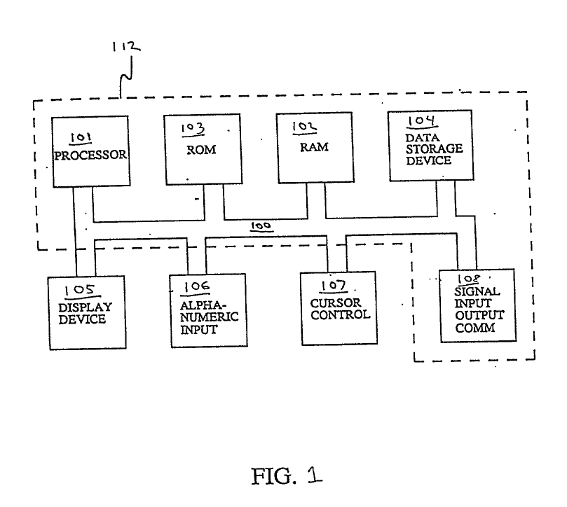

Refer to FIG. 1 which illustrates a computer system 112. In general, computer systems 112 used by the preferred embodiment of the present invention comprise a bus 100 for communicating information, a central processor 101 coupled with the bus 100 for processing information and instructions, a random access memory 102 coupled with the bus 100 for storing information and instructions for the central processor 101, a read only memory 103 coupled with the bus 100 for storing static information and instructions for the processor 101, a data storage device 104 such as a magnetic or optical disk and disk drive coupled with the bus 100 for storing information and instructions, a display device 105 coupled to the bus 100 for displaying information to the computer user, an alphanumeric input device 106 including alphanumeric and function keys coupled to the bus 100 for communicating user input information and command selections to the central processor 101, cursor control device 107 coupled to the bus for communicating user input information and command selections to the central processor 101, and a signal generating device 108 coupled to the bus 100 for communicating command selections to the processor 101.

The display device 105 of FIG. 1 utilized with the computer system of the present invention may be a liquid crystal device, cathode ray tube or other display device suitable for creating graphic images and alphanumeric characters recognizable to the user. The cursor control device 107 allows the computer user to dynamically signal the two dimensional movement of a visible symbol (pointer) on a display screen of the display device 105. Many implementations of the cursor control device are known in the art including a trackball, mouse, joystick or special keys on the alphanumeric input device 105 capable of signaling movement of a given direction or manner of displacement. It is to be appreciated that the cursor means 107 also may be directed and/or activated via input from the keyboard using special keys and key sequence commands. Alternatively, the cursor may be directed and/or activated via input from a number of specially adapted cursor directing devices.

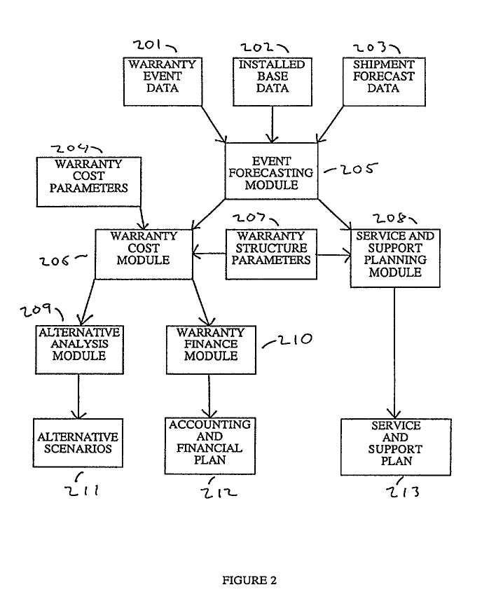

FIG. 2 shows a system embodiment of the invention. This particular system embodiment comprises four functional modules. The functional modules may be software modules on a computer or may include human participation in performing the functions. The invention is an integrated system approach that is base on one date source for multiple purposes. This one data source enables much more accurate warranty planning and provides early indicators when warranty expenses get out of hand. The one data source includes three data types. The three data types are shown as inputs in FIG. 2, and are processed to provide three outputs. The warranty event data 201 includes information regarding customer service events due to real and perceived product failures, and the date of their occurrence. The event may be associated with a failure of an electrical or mechanical component, or may be a software “bug”. Data concerning eventss also includes information regarding the time of the event. Examples of time related information are the actual time of the event and the time at which the event is detected. The time of the actual event and the time of detection may or may not be coincident. In some cases analysis of the event will enable the determination of an accurate estimate of the actual time of the event estimated from the time of detection. In the case of a piece of equipment that is used periodically or is usually on standby, the time of the event may be an interpolation between the last date of normal use and the time of detection. time related information may also be expressed in terms of duty cycles.

A single product such as a laser printer may have electronic components such as memory or a microprocessor that are stressed by turning the printer on an off, and mechanical components in the paper transport that do not experience wear unless actual printing is done. Based upon the known characteristics of a given device, an equivalence between duty cycles and time can be derived, so that an effective time of the failure event, or normalized time of the failure event can be obtained. A heavily used device may experience a failure event after a short chronological period, but have a longer effective time for the failure event than a lightly used device with the same type of failure event after a long chronological period.

In addition to data regarding real failures, the warranty event data may also contain information related to events for which no failure occurred, but required service nonetheless. An example of such an event would be a telephone call to technical support by a user of a software application. Technical support personnel frequently spend time educating users on the basics of the computer they are using in order to facilitate the installation and use of the application they are supporting. Interactions with a customer that require the allocation of resources but do not involve an actual product failure are defined as non-failure warranty events. Failure data is typically acquired by development and production engineering functions in order to improve product performance or production.

Installed product base data 202 includes information concerning when each item was shipped. In many instances when a device is repaired, it is essentially rejuvenated and it is treated as a new shipment after repair. This rejuvenation may apply to the device as whole, as in instances when a device typically fails by going out of calibration as opposed to failing due to wear or aging of a component. For devices with long-lived components, recalibration produces an essentially new device. For devices composed of parts that have a wide distribution of useful lifetimes, the populations of individual parts may be tracked separately. The installed product base information concerns the product population that is under warranty, and in general is the number of units shipped, minus those that have been removed from service or are no longer under warranty or service.

Product shipment forecast data 203 may include information regarding units for which there are firm orders but have not been delivered, or it may include numbers based upon past experience or market surveys. This data is particularly useful when the establishment of service and support requires a significant lead time.

The product data from sources 201, 202 and 203 (i.e. raw data) is input to the event forecasting module 205. It is important to note that the input data is time resolved and is based upon discrete events localized in time, as opposed to aggregated data associated with a number of events over an extended period of time. the event forecasting engine performs a statistical analysis of the data and produces a “best fit” model for the event rate of failure and non-failure warranty events over time. Linear, power, exponential and logarithmic functions are examples of functions that can be used individually or in combination to provide a “best fit”. The event rate is forecast as a function of time, and is not necessarily a fixed rate. An event rate model that is time dependent (not constant) requires a sophisticated convolutionary method in order to translate the forecasted event rate to “events”. This method is provided with the invention. The output of the failure forecasting module 205 is available as input for the warranty cost module 206 and the service and support planning module 208.

The warranty cost module 206 accepts the event forecast developed by the failure forecasting module 205, the warranty cost parameters 204, and warranty structure parameters 207 as inputs. The warranty cost parameters 204 include information such as the cost of replacement parts and labor. The warranty structure parameters 207 include the terms of the warranty, e.g. what is covered under the warranty and for how long. The time related parameters may include time normalized data.Based upon the inputs, the warranty cost module calculates the expected warranty cost over time. The output of the warranty cost module is available as input to the alternative analysis module 209 and the warranty finance module 210.

The service and support planning module accepts the output of the event forecasting module 205 and the warranty structure parameters 207 as inputs. Based upon what the warranty will cover and for how long, and the expected event rate over time, a service and support plan 213 is developed to ensure that sufficient capacity is put in place to meet the warranty commitments.

The alternative analysis module 209 accepts as input the warranty cost function developed by the warranty cost module 206. The alternative analysis module 209 provides scenario-planning capabilities to test alternative warranty strategies. This capability may be recursive in nature in that the input and functions of the complementary portion of the system is nested in the alternative analysis module along with a means for producing incremental variations in the input data and parameters. The alternative analysis module 209 produces as output alternative scenarios 211.

The warranty finance module 210 accepts as input the warranty cost function developed by the warranty cost module 206. This module plans and aggregates accruals and de-accruals for expect warranty expenses and may also include a monitoring system that issues warnings when realized warranty costs exceed preset control limits. Both of these functions may be performed automatically.

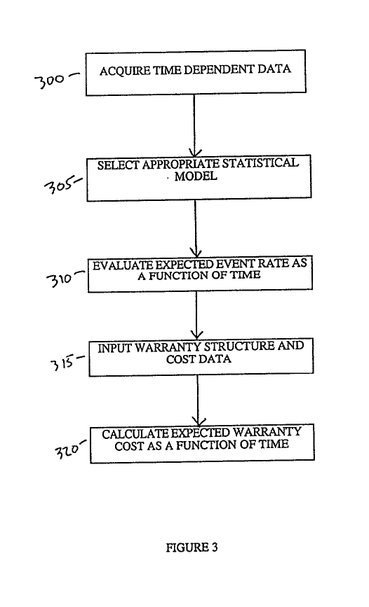

FIG. 3 shows a flow chart for a method embodiment of the present invention that may be performed by the system shown in FIG. 2. At step 300 time dependent data is acquired. This data may include product failures and non-failure warranty events. In the succeeding step 305 the time dependent data is analyzed and the appropriate statistical model is selected. In the following step 310, the statistical model is applied and the expected event rate over time function is calculated. In the next step 315 warranty structure data and warranty cost data are combined with the expected event rate over time function, and in the final step 320, the expected warranty cost over time is calculated.

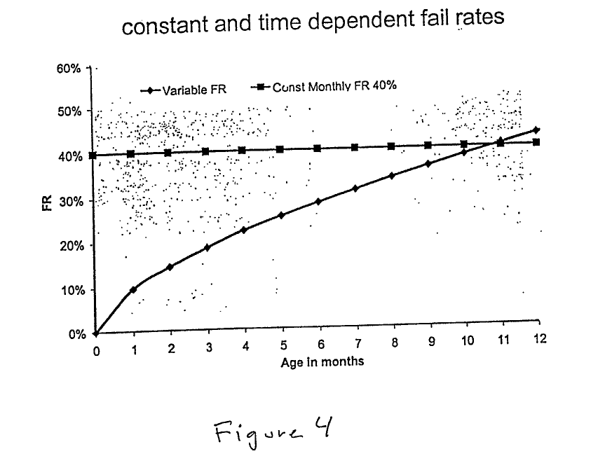

FIG. 4 compares a typical fixed failure rate plotted with the square symbols, and a time variable event rate (e.g. generated by the Event Forecasting Module 205) plotted with the diamond symbols derived for the same product. In this example, the fixed failure rate is given as 40%. As can be seen from the behavior of the two curves, the fixed failure rate curve overestimates events at the beginning of the product population lifetime. Since the two plots are based upon the same product, the area under each curve under would be the same if the full lifespan were plotted. That is, the time integral of the two rates would result in the same number of total events over the life of the product. However, the warranty life and product life are usually not the same, and as shown in FIG. 4, if the warranty life is 12 months or less, the event rate will be overestimated for most of the warranty life. The constant failure rate obtained from an average over time is not as accurate as the variable event rate.

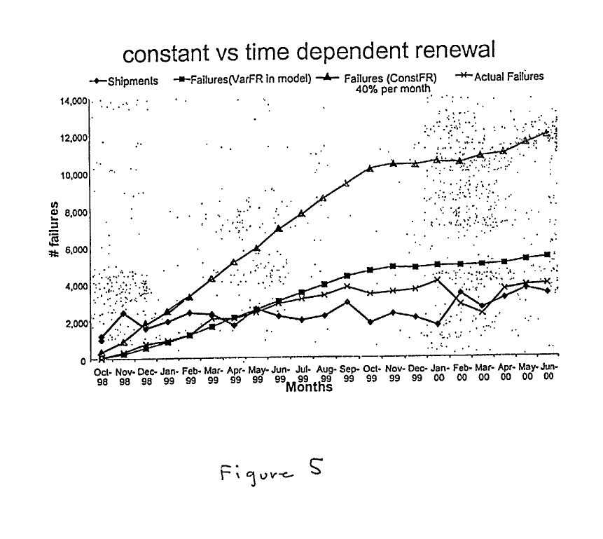

In FIG. 5, actual data is compared to predictions based upon a conventional constant failure rate and a variable event rate with time dependent renewal. The product shipments per month are shown in the curve plotted with the diamond symbols. Total events over time for the variable event rate model of the present invention are plotted using the square symbols. Total events over time for a constant failure rate of 40%/month are plotted using the triangle symbols, and total actual events over time are plotted with the cross symbols. When events are serviced, and thus the product is renewed, the population event behavior is changed and a considerable error develops over time with the prediction derived from a constant failure rate that does not take into account the impact of event servicing behavior. On the other hand, the variable event rate of the present invention can accommodate the change in behavior, and exhibits a much smaller error. This is in part due to the discrimination between failure and non-failure warranty events that is incorporated in the Variable Event Rate Model, but lacking in the Annual Failure Rate (AFR).

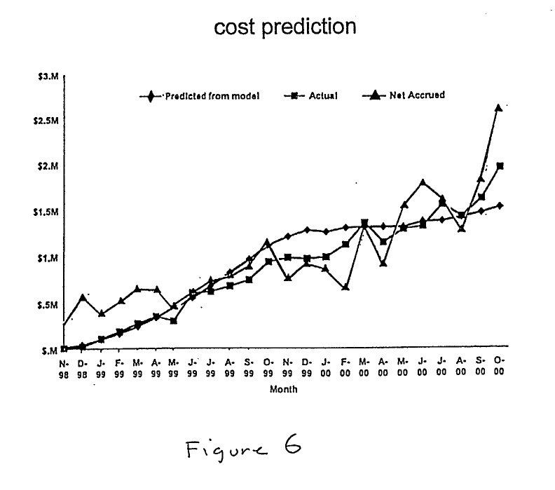

FIG. 6 shows the impact that the fixed failure rate as shown in FIG. 4, has on the accruals for warranty of a product. The required accrual over time predicted by the model is plotted with the diamond symbols. The net accrued using an underlying constant failure rate is plotted using the triangle symbols, and the actual cost is plotted using the square symbols. For the first six months, the accruals are considerably higher than the actual cost when made on the basis of a constant failure rate, whereas the prediction based upon the variable time dependent event rate conforms well with the actual cost. Further, the amplitude of both the negative and positive deviations from actual are smaller for the variable event rate model. The accurate accrual for warranty costs allows for more efficient allocation of financial resources during a given period of time, and for the period of time as a whole.

Reliability modeling is widely spread in the engineering world, but is usually not used for financial planning purposes. The invention is an integrated system approach that is based on one data source for multiple purposes. This one data source enables much more accurate warranty planning and provides early indicators when warranty expenses get out of hand. It can help marketing to estimate costs for changes in warranty programs and procedures. In general it facilitates cross-functional understanding of interdependencies between product design, marketing, finance, and customer service and support.

Reliability modeling resides typically in the technical marketing function of a productline, which doesn't have a close link into the financial function. Warranty planning and accounting is typically based on of historical data averages (e.g. annual failure rates, or AFR) or sometimes-pure experience. The advantage of linking reliability modeling and warranty financial planning lies in the use of actual event data, statistically sound event prediction, discovery of event behavior over time and the immediate translation into financial data for warranty accruals and budgeting for service and support. This advantage is provided by the VERM. Warranty is often viewed as differentiator for sales, but often it is not clear what the impact of warranty program changes have on warranty costs. A flexible what-if analysis tool can give quick answers and projections of expected costs. Last, capacity planning for service and support is directly linked to the reliability of products. Capacity planning that is based on actual data and statistical prediction of failures over time is more accurate that plans that are based on averages.

The preferred embodiment of the present invention, a system and method for integrated reliability and financial planning, is thus described, While the present invention has been described in particular embodiments, it should be appreciated that the present invention should not be construed as limited by such embodiments, but rather construed according to the below claims.

What is claimed is:

1. An integrated reliability and warranty planning system for managing costs associated with a product, comprising:
a data source having raw data associated with said product;
a first modeling module adapted to generate time dependent warranty event prediction data based on said raw data; and
a second modeling module adapted to generate warranty cost data based on said time dependent warranty event prediction data and warranty data associated with said product.

2. An integrated reliability and warranty planning system as recited in claim 1 further comprising:
a third module adapted to generate financial data based on said warranty cost data;
a fourth module adapted to plan and to maintain said financial data;
a fifth module adapted to plan and to determine service and support resources based on said time dependent warranty event prediction data; and
a sixth module adapted to analyze change in said warranty cost data due to alternative warranty data.

3. An integrated reliability and warranty planning system as recited in claim 1 wherein said warranty finance module is configured to monitor said warranty cost data and to indicate whether said warranty cost data exceeds a threshold cost.

4. An integrated reliability and warranty planning system as recited in claim 1 wherein said raw data includes actual event data, installed product base data, and product shipment forecast data.

5. An integrated reliability and warranty planning system as recited in claim 1 wherein said warranty data includes warranty cost parameters data and warranty structure parameters data.

6. An integrated reliability and warranty planning system for managing costs associated with a product, comprising:
means for receiving raw data associated with said product;
means for generating failure prediction data based on said raw data; and
means for generating warranty cost data based on said time dependent warranty event prediction data and warranty data associated with said product.

7. An integrated reliability and warranty planning system as recited in claim 6 further comprising:
means for generating financial data based on said warranty cost data;
means for planning and maintaining said financial data;
means for planning and determining service and support resources based on said time dependent warranty event prediction data; and
means for analyzing change in said warranty cost data due to alternative warranty data.

8. An integrated reliability and warranty planning system as recited in claim 7 wherein said means for generating said financial data is configured to monitor said warranty cost data and to indicate whether said warranty cost data exceeds a threshold cost.

9. An integrated reliability and warranty planning system as recited in claim 6 wherein said raw data includes actual event data, installed product base data, and product shipment forecast data.

10. An integrated reliability and warranty planning system as recited in claim 6 wherein said warranty data includes warranty cost parameters data and warranty structure parameters data.

11. A method of integrating reliability and warranty planning for a product, comprising the steps of:
a) receiving raw data associated with said product;
b) generating time dependent warranty event prediction data based on said raw data; and
c) generating warranty cost data based on said time dependent warranty event prediction data and warranty data associated with said product.

12. A method as recited in claim 11 further comprising the steps of:
generating financial data based on said warranty cost data;
planning and maintaining said financial data;
planning and determining service and support resources based on said time dependent warranty event prediction data; and
analyzing change in said warranty cost data due to alternative warranty data.

13. A method as recited in claim 12 further including the steps of monitoring said warranty cost data and indicating whether said warranty cost data exceeds a threshold cost.

14. A method as recited in claim 11 wherein said raw data includes actual event data, installed product base data, and product shipment forecast data.

15. A method as recited in claim 11 wherein said warranty data includes warranty cost parameters data and warranty structure parameters data.

16. A computer-readable medium comprising computer-executable instructions stored therein for performing a method of integrating reliability and warranty planning for a product, said method comprising the steps of:
a) receiving raw data associated with said product;
b) generating time dependent warranty event prediction data based on said raw data; and
c) generating warranty cost data based on said time dependent warranty event prediction data and warranty data associated with said product.

17. A computer-readable medium as recited in claim 16 wherein said method further comprises the steps of:
generating financial data based on said warranty cost data;
planning and maintaining said financial data;
planning and determining service and support resources based on said time dependent warranty event prediction data; and
analyzing change in said warranty cost data due to alternative warranty data.

18. A computer-readable medium as recited in claim 17 wherein said method further includes the steps of monitoring said warranty cost data and indicating whether said warranty cost data exceeds a threshold cost.

19. A computer-readable medium as recited in claim 16 wherein said raw data includes actual event data, installed product base data, and product shipment forecast data.

20. A computer-readable medium as recited in claim 16 wherein said warranty data includes warranty cost parameters data and warranty structure parameters data.
